(19) United States
(12) Patent Application Publication
(10) Pub. No.: US 2003/0108776 A1
(43) Pub. Date: Jun. 12, 2003

(54) Pseudo-laminated soft underlayers for perpendicular magnetic recording media

(75) Inventors: Chung-Hee Chang, Fremont, CA (US); Charles F. Brucker, Pleasanton, CA (US); Rajiv Yadav Ranjan, San Jose, CA (US)

Correspondence Address: MCDERMOTT, WILL & EMERY, 600 13th Street, N.W., Washington, DC, 20005-3096, US

(73) Assignee: Seagate Technology LLC

(21) Appl. No.: 10/143,983

(22) Filed: May 14, 2002

Related U.S. Application Data
(60) Provisional application No. 60/338,372, filed on Dec. 6, 2001.
(60) Provisional application No. 60/338,447, filed on Dec. 6, 2001.

(51) Int. Cl. G11B 5/66

(52) U.S. Cl. 428/694 TM; 428/694 TS; 428/694 T; 428/694 R

(57) ABSTRACT

A high areal recording density, perpendicular magnetic recording medium with reduced or substantially zero DC noise, comprising:

(a) a non-magnetic substrate having a surface; and

(b) a layer stack formed over the substrate surface and comprising, in overlying sequence from the substrate surface:

(i) a magnetically soft underlayer;

(ii) at least one non-magnetic interlayer; and

(iii) a magnetically hard perpendicular recording layer;

wherein the magnetically soft underlayer (b)(i) is thicker than the magnetically hard perpendicular recording layer (b)(iii) and is a pseudo-laminated structure composed of a stacked plurality of sub-layers of a magnetically soft material.

### CROSS-REFERENCE TO PROVISIONAL APPLICATIONS

This application claims priority from U.S. provisional patent application Serial Nos. 60/338,372 and 60/338,447, each filed Dec. 6, 2001 the entire disclosures of which are incorporated herein by reference.

### FIELD OF THE INVENTION

The present invention relates to a method for manufacturing improved perpendicular magnetic recording media with reduced DC noise and to perpendicular recording media obtained thereby. The present invention is of particular utility in the manufacture and use of data/information storage and retrieval media, e.g., hard disks, with ultra-high areal recording densities and very low noise characteristics.

### BACKGROUND OF THE INVENTION

Magnetic media are widely used in various applications, particularly in the computer industry, and efforts are continually made with the aim of increasing the areal recording density, i.e., bit density of the magnetic media. In this regard, so-called “perpendicular” recording media have been found to be superior to the more conventional “longitudinal” media in achieving very high bit densities. In perpendicular magnetic recording media, residual magnetization is formed in a direction perpendicular to the surface of the magnetic medium, typically a layer of a magnetic material on a suitable substrate. Very high linear recording densities are obtainable by utilizing a “single-pole” magnetic transducer or “head” with such perpendicular magnetic media.

It is well-known that efficient, high bit density recording utilizing a perpendicular magnetic medium requires interposition of a relatively thick (i.e., as compared to the magnetic recording layer), magnetically “soft” underlayer (“SUL”), i.e., a magnetic layer having relatively low coercivity, such as of a Ni—Fe alloy (Permalloy), between the non-magnetic substrate, e.g., of glass, aluminum (Al) or an Al-based alloy, and the “hard” magnetic recording layer, e.g., of a cobalt-based alloy (e.g., a Co—Cr alloy) having perpendicular anisotropy or of a (CoX/Pd or Pt)ₙ multi-layer superlattice structure. The magnetically soft underlayer serves to guide magnetic flux emanating from the head through the magnetically hard, perpendicular magnetic recording layer. In addition, the magnetically soft underlayer reduces susceptibility of the medium to thermally-activated magnetization reversal by reducing the demagnetizing fields which lower the energy barrier that maintains the current state of magnetization.

A typical perpendicular recording system 10 utilizing a vertically oriented magnetic medium 1 with a relatively thick soft magnetic underlayer, a relatively thin hard magnetic recording layer, and a single-pole head, is illustrated in FIG. 1, wherein reference numerals 2, 3, 4, and 5, respectively, indicate the substrate, soft magnetic underlayer, at least one non-magnetic interlayer, and vertically oriented, hard magnetic recording layer of perpendicular magnetic medium 1, and reference numerals 7 and 8, respectively, indicate the single and auxiliary poles of single-pole magnetic transducer head 6. Relatively thin interlayer 4 (also referred to as an “intermediate” layer), comprised of one or more layers of non-magnetic materials, illustratively a pair of layers 4_{A} and 4_{B}, is provided in a thickness sufficient to prevent (i.e., de-couple) magnetic interaction between the soft underlayer 3 and the hard recording layer 5 but should be as thin as possible in order to minimize the spacing HSS between the lower edge of the transducer head 6 and the upper edge of the magnetically soft underlayer 3. Spacing HMS between the lower edge of the transducer head 6 and the upper edge of the hard magnetic recording layer 5 is also minimized during operation of system 10. In addition to the above, interlayer 4 also serves to promote desired microstructural and magnetic properties of the hard recording layer 5.

As shown by the arrows in the figure indicating the path of the magnetic flux φ, flux φ is seen as emanating from single pole 7 of single-pole magnetic transducer head 6, entering and passing through vertically oriented, hard magnetic recording layer 5 in the region above single pole 7, entering and travelling along soft magnetic underlayer 3 for a distance, and then exiting therefrom and passing through vertically oriented, hard magnetic recording layer 5 in the region above auxiliary pole 8 of single-pole magnetic transducer head 6. The direction of movement of perpendicular magnetic medium 1 past transducer head 6 is indicated in the figure by the arrow above medium 1.

With continued reference to FIG. 1, vertical lines 9 indicate grain boundaries of each polycrystalline (i.e., granular) layer of the layer stack constituting medium 1. As apparent from the figure, the width of the grains (as measured in a horizontal direction) of each of the polycrystalline layers constituting the layer stack of the medium is substantially the same, i.e., each overlying layer replicates the grain width of the underlying layer. Completing medium 1 are a protective overcoat layer 11, such as a layer of diamond-like carbon (DLC) formed over hard magnetic layer 5, and a lubricant topcoat layer 12, such as a layer of a perfluoropolyethylene material, formed over the protective overcoat layer 11. Substrate 2 is typically disk-shaped and comprised of a nonmagnetic metal or alloy, e.g., Al or an Al-based alloy, such as Al—Mg having an Ni—P plating layer on the deposition surface thereof, or substrate 2 is comprised of a suitable glass, ceramic, glass-ceramic, polymeric material, or a composite or laminate of these materials and may include an adhesion layer 2_{A} at the upper surface thereof, typically comprised of an about 10 to about 50 Å thick layer of Cr; soft magnetic underlayer 3 is typically comprised of an about 2,000 to about 4,000 Å thick layer of a soft magnetic material selected from the group consisting of Ni, NiFe (Permalloy), Co, CoFe, Fe, FeN, FeSiAl, FeSiAlN, etc.; the at least one interlayer 4 typically comprises a layer or a pair of up to about 10 Å thick layers 4_{A}, 4_{B} of at least one non-magnetic material, such as Pt, Pd, Ta, Ru, Ti, TiCr, and Co-based alloys; and hard magnetic layer 5 is typically comprised of an about 100 to about 300 Å thick layer of a Co-based alloy including one or more elements selected from the group consisting of Cr, Fe, Ta, Ni, Mo, Pt, V, Nb, Ge, and B, iron oxides, such as Fe₃O₄ and δ-Fe₂O₃, or a (CoX/Pd or Pt)ₙ multilayer magnetic superlattice structure, where n is an integer from about 10 to about 25, each of the alternating, thin layers of Co-based magnetic alloy is from about 2 to about 3.5 Å thick, X is an element selected from the group consisting of Cr, Ta, B, Mo, and Pt, and each of the alternating thin, non-magnetic layers of Pd or Pt is about 10 A thick. Each type of hard magnetic recording layer material has perpendicular anisotropy arising from magneto-crystalline anisotropy (1^{st} type) and/or interfacial anisotropy (2^{nd} type).

So-called “double-layer” perpendicular media such as described above and illustrated in FIG. 1, comprise a relatively thick soft magnetic underlayer (“SUL”) 3 of a high magnetization (Ms) material (such as those enumerated supra) which exhibits in-plane anisotropy dominated by shape anisotropy 4RMs. However, since the SUL 3 is relatively thick, i.e., typically from about 2,000 to about 4,000 Å thick, it becomes difficult to maintain the magnetizations in an in-plane direction due to a perpendicular anisotropy component attributable to various factors, i.e., magneto-crystalline anisotropy and magneto-elastic anisotropy (see E. E. Huber et al., J Appl. Phys. (suppl.) 30, 267S (1959) and S. K. Wang et al., IEEE Trans. Magn. 35, 782 (1999)). Perpendicular components of magnetizations caused by the perpendicular anisotropy component form “stripe” or “ripple” shaped domains (see K. Sin et al., IEEE Trans. Magn. 33, 2833 (1997) and N. Saito et al., J. Phys. Soc. Japan 19, 1116 (1964)), resulting in a significant amount of DC noise. According to common practice, the perpendicular anisotropy component in soft magnetic films attributable to the magneto-elastic anisotropy factor can be relieved by thermal annealing (see Jun Yu et al., MMM 2001 Conference).

Another way by which the perpendicular anisotropy component of the SUL may be suppressed is to form a laminated SUL structure, as by depositing a layer stack or laminate comprised of alternating layers of different materials (see F. Nakamura et al., 5th Perpendicular Magnetic Recording Conference (PMRC 2000), Sendai, Japan, October 23-26, 2000, paper 23pA-13). Referring to FIG. 2, such a laminated SUL structure 3_{L} consists of a stacked plurality of alternating relatively thicker soft magnetic layers 3_{M} and relatively thinner spacer layers 3_{S} formed over the surface of a suitable substrate 2. As before, an adhesion layer ²A may be provided on the upper surface of the substrate 2, at the interface with the lowermost soft magnetic layer 3_{M}, which adhesion layer 2_{A} may be formed of the same material as that of the spacer layers 3_{S}. It is believed that the beneficial effect afforded by formation of the laminated SUL structure 3_{L} is obtained from a reduction of the perpendicular anisotropy component in polycrystalline soft magnetic films attributable to the magneto-crystalline anisotropy factor, the latter arising from disruption of columnar growth in the films.

The amount by which the perpendicular anisotropy component is suppressed is expected to be proportional to the number of lamination cycles 3_{M}/3_{S}; consequently, a greater number of lamination cycles is presumed to be better in terms of the amount of suppression of the perpendicular anisotropy component. Disadvantageously, however, the number of lamination cycles 3_{M}/3_{S} which is possible in automated, continuous manufacturing practice is greatly limited by the number of process stations available in the conventionally utilized production apparatus (typically multi-station sputtering apparatus) for forming the laminated SUL structure 3_{L} Further, formation of the above-described laminated SUL structures requires additional process stations for formation of each of the spacer layers 3_{S}, as well as specially designed sputtering sources or a typical operation of the sputtering apparatus, e.g., multiple passes of the substrates through the apparatus.

In view of the foregoing, there exists a clear need for a viable, cost-effective alternative process/methodology for forming laminated SUL structures or their functional equivalents, which alternative process/methodology effectively avoids the above-described disadvantages and drawbacks associated with the conventional manufacturing methodology/technology. Moreover, there exists a clear need for economically viable methodology for forming ultra-high areal density, perpendicular magnetic recording media exhibiting very low DC noise levels not obtainable according to conventional manufacturing methodology.

The present invention, therefore, addresses and solves problems attendant upon the manufacture of ultra-high areal density, perpendicular magnetic recording media comprising laminated soft magnetic underlayer structures for DC noise reduction, and/or their functional equivalents thereof, while maintaining full compatibility with the economic requirements of large-scale, automated manufacturing technology.

### DISCLOSURE OF THE INVENTION

An advantage of the present invention is an improved high areal recording density, perpendicular magnetic recording medium with reduced or substantially zero DC noise.

Another advantage of the present invention is an improved pseudolaminated, magnetically soft underlayer structure for use in the fabrication of improved high areal recording density, perpendicular magnetic recording medium with reduced or substantially zero DC noise.

Still another advantage of the present invention is an improved method of manufacturing a high areal recording density, perpendicular magnetic recording medium with reduced or substantially zero DC noise.

Yet another advantage of the present invention is an improved disk drive comprising a low DC noise perpendicular magnetic recording medium including a pseudo-laminated soft underlayer structure Additional advantages and other features of the present invention will be set forth in the description which follows and in part will become apparent to those having ordinary skill in the art upon examination of the following or may be learned from the practice of the present invention. The advantages of the present invention may be realized as particularly pointed out in the appended claims.

According to an aspect of the present invention, the foregoing and other advantages are obtained in part by a high areal recording density, perpendicular magnetic recording medium with reduced or substantially zero DC noise, comprising:

(a) a non-magnetic substrate having a surface; and

(b) a layer stack formed over the substrate surface, the layer stack comprising, in overlying sequence from the substrate surface:

(i) a magnetically soft underlayer;

(ii) at least one non-magnetic interlayer; and

(iii) a magnetically hard perpendicular recording layer;

wherein the magnetically soft underlayer (b)(i) is thicker than the magnetically hard perpendicular recording layer (b)(iii) and is a pseudo-laminated structure composed of a stacked plurality of sub-layers of a magnetically soft material.

According to embodiments of the present invention, the layer stack (b) further comprises an adhesion layer between the substrate surface and the magnetically soft underlayer (b)(i), the adhesion layer comprising an about 10 to about 50 Å thick layer of a material selected from the group consisting of Ti, Cr, Ta, Zr, Nb, Fe, Co, Ni, and alloys thereof; and the magnetically soft underlayer (b)(i) is composed of a stacked plurality of sub-layers of a magnetically soft material selected from the group consisting of FeCoB, CoZr, CoZrCr, CoZrNb, CoTaZr, CoFeZr, and FeTaC.

In accordance with certain embodiments of the present invention, the magnetically soft underlayer (b)(i) is composed of a stacked plurality of sub-layers of a FeCoB alloy, e.g., the magnetically soft underlayer (b)(i) is composed of 2-6 stacked sub-layers of (Fe₆₅Co₃₅)₈₈B₁₂, e.g., 3 sub-layers, each having a thickness from about 50 to about 130 nm.

According to embodiments of the present invention, the at least one nonmagnetic interlayer (b)(ii) comprises an up to about 10 Å thick layer or layers of at least one non-magnetic material selected from the group consisting of Pt, Pd, Ta, Re, Ru, Hf, alloys thereof, Ti—Cr, and Co-based alloys; and the magnetically hard perpendicular recording layer (b)(iii) is from about 100 to about 300 Å thick and comprises a Co-based alloy including one or more elements selected from the group consisting of Cr, Fe, Ta, Ni, Mo, Pt, V, Nb, Ge, and B, or an iron oxide selected from Fe₃O₄ and δ-Fe₂O₃, or a (CoX/Pd or Pt)ₙ multilayer magnetic superlattice structure comprised of alternating thin layers of a Co-based magnetic alloy and non-magnetic Pd or Pt, where n is an integer from about 10 to about 25, each of the alternating thin layers of Co-based magnetic alloy is from about 2 to about 3.5 Å thick, X is an element selected from the group consisting of Cr, Ta, B, Mo, and Pt, and each of the alternating thin layers of non-magnetic Pd or Pt is about 10 Å thick.

In accordance with particular embodiments of the present invention, the magnetically hard perpendicular recording layer (b)(iii) comprises a CoCrPt alloy; the non-magnetic substrate (a) comprises a material selected from the group consisting of Al, NiP-plated Al, Al—Mg alloys, other Al-based alloys, other nonmagnetic metals, other non-magnetic alloys, glass, ceramics, polymers, glass-ceramics, and composites and/or laminates thereof; and the medium further comprises a protective overcoat layer (c) over the magnetically hard perpendicular recording layer (b)(iii) and a lubricant topcoat layer (d) over the protective overcoat layer (c).

According to embodiments of the present invention, the non-magnetic substrate (a) comprises a material selected from the group consisting of Al, NiP-plated Al, Al—Mg alloys, other Al-based alloys, other non-magnetic metals, other non-magnetic alloys, glass, ceramics, polymers, glass-ceramics, and composites and/or laminates thereof; and the layer stack (b) comprises: an adhesion layer between the substrate surface and the magnetically soft underlayer (b)(i), the adhesion layer comprising an about 10 to about 50 Å thick layer of a material selected from the group consisting of Ti, Cr, Ta, Zr, Nb, Fe, Co, Ni, and alloys thereof; a magnetically soft underlayer (b)(i) in the form of a pseudo-laminated structure composed of 2-6 stacked sub-layers of a FeCoB alloy, e.g., 3 sub-layers, each having a thickness from about 50 to about 130 nm; at least one nonmagnetic interlayer (b)(ii) in the form of an up to about 10 Å thick layer or layers of at least one non-magnetic material selected from the group consisting of Pt, Pd, Ta, Re, Ru, Hf, alloys thereof, Ti—Cr, and Co-based alloys; and a magnetically hard perpendicular recording layer (b)(iii) in the form of an about 100 to about 300 Å thick layer comprised of a Co-based alloy including one or more elements selected from the group consisting of Cr, Fe, Ta, Ni, Mo, Pt, V, Nb, Ge, and B, or an iron oxide selected from Fe₃O₄ and δ-Fe₂O₃, or a (CoX/Pd or Pt)ₙ multilayer magnetic superlattice structure comprised of alternating thin layers of a Co-based magnetic alloy and non-magnetic Pd or Pt, where n is an integer from about 10 to about 25, each of the alternating thin layers of Co-based magnetic alloy is from about 2 to about 3.5 Å thick, X is an element selected from the group consisting of Cr, Ta, B, Mo, and Pt, and each of the alternating thin non-magnetic layers of Pd or Pt is about 10 Å thick.

Another aspect of the present invention is a method of manufacturing a high areal recording density, perpendicular magnetic recording medium with reduced or substantially zero DC noise, comprising the steps of:

(a) providing a non-magnetic substrate having a surface; and

(b) forming a layer stack over the substrate surface, comprising steps for forming, in overlying sequence from the substrate surface:

(i) a magnetically soft underlayer;

(ii) at least one non-magnetic interlayer; and

(iii) a magnetically hard perpendicular recording layer;

wherein step (b)(i) comprises forming a pseudo-laminated structure having a thickness greater than that of the magnetically hard perpendicular recording layer formed in step (b)(iii) and composed of a plurality of sub-layers of magnetically soft material.

According to embodiments of the present invention, step (b)(i) comprises forming a pseudo-laminated structure composed of a stacked plurality of sub-layers of a magnetically soft material selected from the group consisting of FeCoB, CoZr, CoZrCr, CoZrNb, CoTaZr, CoFeZr, and FeTaC.

In accordance with certain embodiments of the present invention, step (b)(i) comprises forming a pseudo-laminated structure composed of a stacked plurality of sub-layers of a FeCoB alloy; e.g., step (b)(i) comprises forming a pseudo-laminated structure composed of 2-6 stacked sub-layers of (Fe₆₅Co₃₅)₈₈B₁₂, e.g., 3 sub-layers, each having a thickness from about 50 to about 130 nm.

According to embodiments of the present invention, step (b)(i) comprises forming the pseudo-laminated structure by a physical vapor deposition (PVD) process, preferably a sputtering process; and according to alternative practices according to the present invention, step (b)(i) comprises forming the pseudolaminated structure composed of a stacked plurality of sub-layers of a soft magnetic material by depositing each sub-layer in a different chamber, or step (b)(i) comprises forming the pseudo-laminated structure composed of a stacked plurality of sub-layers of a soft magnetic material by discontinuous, sequential deposition of each sub-layer in the same chamber.

In accordance with embodiments of the present invention, step (a) comprises providing a non-magnetic substrate comprised of a material selected from the group consisting of Al, NiP-plated Al, Al—Mg alloys, other Al-based alloys, other non-magnetic metals, other non-magnetic alloys, glass, ceramics, polymers, glass-ceramics, and composites and/or laminates thereof; step (b) further comprises forming an adhesion layer over the substrate surface prior to performing step (b)(i), e.g., an about 10 to about 50 Å thick layer of a material selected from the group consisting of Ti, Cr, Ta, Zr, Nb, Fe, Co, Ni, and alloys thereof; step (b)(ii) comprises forming an up to about 10 Å thick layer or layers of at least one non-magnetic material selected from the group consisting of Pt, Pd, Ta, Re, Ru, Hf, alloys thereof, Ti—Cr, and Co-based alloys; and step (b)(iii) comprises forming an about 100 to about 300 Å thick layer comprised of a Co-based alloy including one or more elements selected from the group consisting of Cr, Fe, Ta, Ni, Mo, Pt, V, Nb, Ge, and B, or an iron oxide selected from Fe₃O₄ and δ-Fe₂O₃, or a (CoX/Pd or Pt)ₙ multilayer magnetic superlattice structure comprised of alternating thin layers of a Co-based magnetic alloy and nonmagnetic Pd or Pt, where n is an integer from about 10 to about 25, each of the alternating thin layers of Co-based magnetic alloy is from about 2 to about 3.5 Å thick, X is an element selected from the group consisting of Cr, Ta, B, Mo, and Pt, and each of the alternating thin layers of non-magnetic Pd or Pt is about 10 Å thick.

Still another aspect of the present invention is a high areal recording density, perpendicular magnetic recording medium with reduced or substantially zero DC noise, comprising:

(a) a perpendicular magnetic recording layer; and

(b) means for reducing or substantially eliminating DC noise of the medium.

A still further aspect of the present invention is a disk drive comprising a low DC noise perpendicular magnetic recording medium including a pseudo-laminated soft underlayer structure according to the present invention.

Additional advantages and aspects of the present invention will become readily apparent to those skilled in the art from the following detailed description, wherein embodiments of the present invention are shown and described, simply by way of illustration of the best mode contemplated for practicing the present invention. As will be described, the present invention is capable of other and different embodiments, and its several details are susceptible of modification in various obvious respects, all without departing from the spirit of the present invention. Accordingly, the drawings and description are to be regarded as illustrative in nature, and not as limitative.

### BRIEF DESCRIPTION OF THE DRAWINGS

The following detailed description of the embodiments of the present invention can best be understood when read in conjunction with the following drawings, in which the same reference numerals are employed throughout for designating similar features, and the various features are not necessarily drawn to scale but rather are drawn as to best illustrate the pertinent features, wherein:

FIG. 1 schematically illustrates, in simplified cross-sectional view, a portion of a magnetic recording, storage, and retrieval system comprised of a conventional perpendicular type magnetic recording medium including a conventionally structured magnetically soft underlayer (SUL) and a single-pole transducer head;

FIG. 2 schematically illustrates, in simplified cross-sectional view, a portion of a laminated SUL/adhesion layer/substrate structure according to the prior art, for use in forming a perpendicular type magnetic recording medium generally as shown in FIG. 1;

FIG. 3 schematically illustrates, in simplified cross-sectional view, a portion of a pseudo-laminated SUL/adhesion layer/substrate structure according to the present invention, for use in forming a perpendicular type magnetic recording medium generally as shown in FIG. 1;

FIG. 4 schematically illustrates, in simplified cross-sectional view, a portion of a perpendicular type magnetic recording medium according to the present invention and comprising the pseudo-laminated SUL/adhesion layer/substrate structure of FIG. 3;

FIG. 5 is a graph illustrating the DC noise spectrum of a conventional, non-laminated, 200 nm thick FeCoB SUL;

FIG. 6 is a graph illustrating the DC noise spectrum of a 3-layer, pseudolaminated, 200 nm thick FeCoB SUL according to the present invention; and

FIG. 7 illustrates X-ray diffraction patterns obtained for non-laminated, bi-layer, and tri-layer FeCoB SUL structures.

### DESCRIPTION OF THE INVENTION

The present invention addresses and solves problems arising from DC noise generation in perpendicular magnetic recording media which, when utilized with a single pole transducer head, comprise a relatively thick, magnetically soft underlayer (SUL) for guiding magnetic flux emanating from the transducer head such that the magnetic flux enters and exits the relatively thin, magnetically hard recording layer along a prescribed path. More specifically, the present invention is based upon the discovery that the disadvantages and drawbacks associated with conventional, non-laminated SULs and with laminated SULs comprising a stacked plurality of a magnetically soft layers separated by spacer layers, which disadvantages and drawbacks respectively include DC noise generation and difficulty in implementation in a cost-effective manner when utilized in automated manufacturing processing, are readily overcome by a simple and cost-effective alternative process for forming “pseudo-laminated” SULs in which the need for spacer layers for separating vertically adjacent magnetically soft layers of the laminated stack or structure is eliminated, thereby resulting in considerable process simplification and ease of implementation when utilized with conventional equipment/apparatus for continuous, automated manufacture of magnetic recording media.

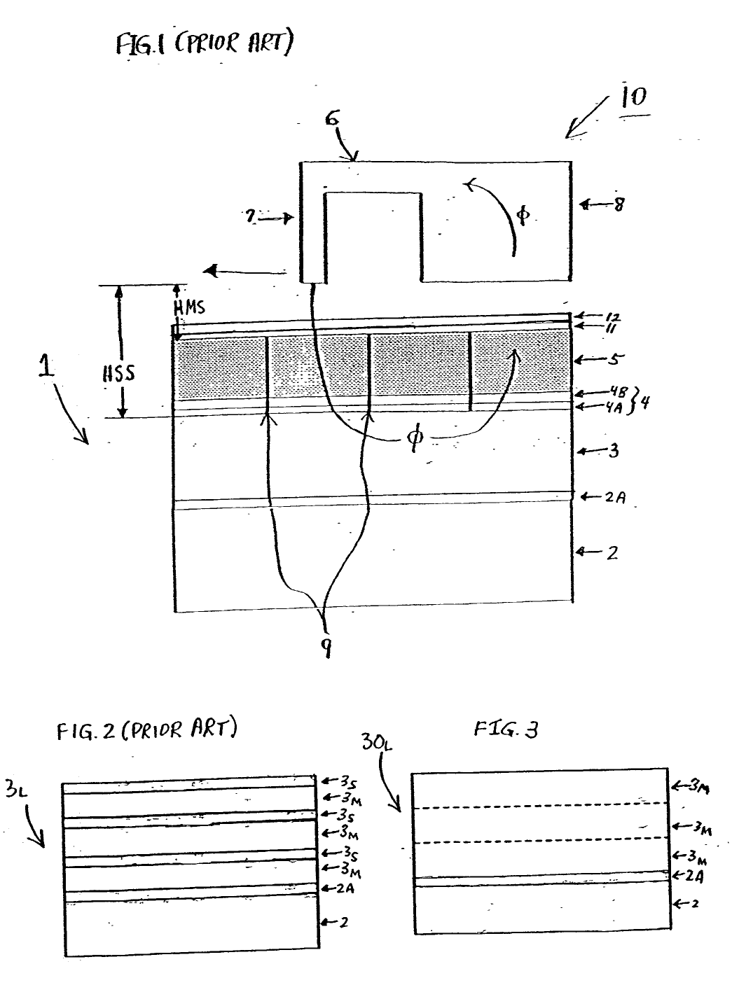

A key feature, therefore, of the present invention, is the formation of “pseudo-laminated” SUL structures consisting of a vertically stacked plurality of identically composed magnetically soft layers, without the presence of any intervening spacer layers, which “pseudo-laminated” SUL structures are obtained by means of a discontinuous deposition process, typically a physical vapor deposition (PVD) process such as sputtering. According to the invention, the discontinuous deposition of successive layers of the same magnetically soft material, without formation of intervening spacer layers, results in the formation of “pseudo-laminated” SUL structures which are at least functionally equivalent to the conventional laminated SUL structures in terms of reduction in DC noise generation. Stated differently, the interval, or delay, between successive layer depositions, whether performed in successive deposition chambers or in the same chamber, is sufficient to create a lamination effect similar to that exhibited by the conventional laminated SUL structures (e.g., as exemplified by the laminated SUL structure illustrated in FIG. 2).

Referring now to FIG. 3, schematically illustrated therein, in simplified cross-sectional view, is a portion of a pseudo-laminated SUL/adhesion layer/substrate structure 30_{L} according to the present invention, for use in forming a perpendicular type magnetic recording medium generally as shown in FIG. 1. Pseudo-laminated SUL/adhesion layer/substrate structure 30_{L} comprises a plurality n (illustratively 3) of vertically stacked magnetically soft sub-layers 3_{M} formed over the surface of a suitable non-magnetic substrate 2 without intervening spacer layers 3_{S} such as are present in the conventional laminated SUL structure 3_{L} of FIG. 2. According to the invention, the (integral) number n and thickness of each of the magnetically soft sub-layers 3_{M} depend upon the particular material thereof, and respectively range from 2 to 6 and from about 50 to about 130 nm. Suitable materials for use as each of the magnetically soft sub-layers 3_{M} include FeCoB, CoZr, CoZrCr, CoZrNb, CoTaZr, CoFeZr, and FeTaC.

As in the conventional laminated SUL structure shown in FIG. 2, pseudo-laminated SUL/adhesion layer/substrate structure 30_{L} may include an adhesion layer 2_{A} formed on the upper surface of the substrate 2, at the interface with the lowermost magnetically soft sub-layer 3_{M}, which adhesion layer 2_{A} may comprise an about 10 to about 50 Å thick layer of a material selected from the group consisting of Ti, Cr, Ta, Zr, Nb, Fe, Co, Ni, and alloys thereof.

As indicated supra, according to the invention, the pseudo-laminated structure 30_{L} may be readily and conveniently formed by sputtering. As a consequence of the elimination of the need for different sputtering target materials for depositing the magnetically soft layers 3_{M} and spacer layers 3_{S}, the inventive methodology affords several advantages vis-à-vis the conventional art, such as increased flexibility of apparatus design/configuration and mode of operation, as well as lower power consumption required for sputtering of a plurality of sub-layers of soft magnetic material rather than a single, thick layer of soft magnetic layer. For example, pseudo-laminated SUL structures according to the present invention may be formed by discontinuous deposition techniques using conventional in-line or circularly-configured, continuously operating sputtering apparatus equipped with multiple process (i.e., sputtering) stations provided with the same target materials for forming respective ones of the magnetically soft layers of the SUL structures, or by use of sputtering apparatus wherein each of the magnetically soft layers of the SUL structures is deposited in the same chamber, as by multiple passes by the same target.

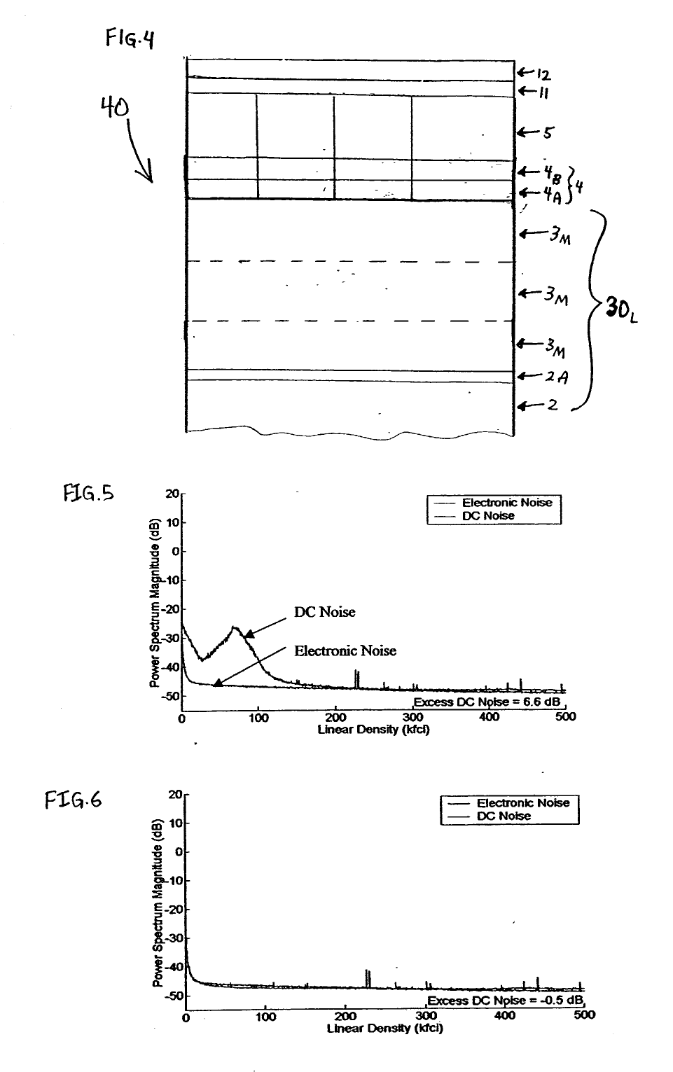

Adverting to FIG. 4, schematically illustrated therein, in simplified cross-sectional view, is a portion of a perpendicular type magnetic recording medium 40 according to the present invention and comprising the pseudo-laminated SUL/adhesion layer/substrate structure 30_{L} of FIG. 3, wherein substrate 2 is typically disk-shaped and comprises a material selected from the group consisting of Al, NiP-plated Al, Al—Mg alloys, other Al-based alloys, other non-magnetic metals, other non-magnetic alloys, glass, ceramics, polymers, glass-ceramics, and composites and/or laminates thereof; adhesion layer 2_{A} at the upper surface of substrate 2 comprises an about 10 to about 50 Å thick layer of a material selected from the group consisting of Ti, Cr, Ta, Zr, Nb, Fe, Co, Ni, and alloys thereof; and n magnetically soft sub-layers 3_{M} (where n is an integer ranging from 2 to 6; illustratively n=3), each from about 50 to about 130 nm thick and composed of a magnetically soft material selected from among Ni, NiFe (Permalloy), Co, FeCoB, CoZr, CoZrCr, CoZrNb, CoTaZr, CoFe, CoFeZr, Fe, FeN, FeSiAl, FeSiAlN, FeTaC, FeAlN, and FeTaN. For example, the pseudo-laminated SUL structure 30_{L} may be comprised of 3 stacked sub-layers of a FeCoB alloy, such as (Fe₆₅Co₃₅)₈₈B₁₂, each having a thickness from about 650 to about 1,300 Å.

Formed on the upper surface of the uppermost magnetically soft sub-layer 3_{M} is a relatively thin interlayer 4 (also referred to as an “intermediate” layer), comprised of one or more layers of non-magnetic materials, illustratively a pair of layers 4_{A} and 4_{B}, provided in a thickness sufficient to prevent (i.e., de-couple) magnetic interaction between the pseudo-laminated SUL structure 30_{L} and the overlying hard recording layer 5 but should be as thin as possible in order to minimize the spacing between the lower edge of a transducer head utilized for reading and/or writing of medium 40 and the upper edge of the uppermost magnetically soft sub-layer 3_{M} Interlayer 4 thus may comprise an up to about 10 Å thick layer or layers of at least one non-magnetic material selected from the group consisting of Pt, Pd, Ta, Re, Ru, Hf, alloys thereof, Ti—Cr, and Co-based alloys. Relatively thin, magnetically hard, perpendicular recording layer 5 is formed atop interlayer(s) 4 and is from about 100 to about 300 Å thick and comprises a Co-based alloy including one or more elements selected from the group consisting of Cr, Fe, Ta, Ni, Mo, Pt, V, Nb, Ge, and B, or an iron oxide selected from Fe₃O₄ and δ-Fe₂O₃, or a (CoX/Pd or Pt)ₙ multilayer magnetic superlattice structure comprised of alternating thin layers of a Co-based magnetic alloy and non-magnetic Pd or Pt, where n is an integer from about 10 to about 25, each of the alternating thin layers of Co-based magnetic alloy is from about 2 to about 3.5 Å thick, X is an element selected from the group consisting of Cr, Ta, B, Mo, and Pt, and each of the alternating thin layers of non-magnetic Pd or Pt is about 10 Å thick.

Completing medium 40 are a protective overcoat layer 11, such as a layer of diamond-like carbon (DLC) formed over hard magnetic layer 5, and a lubricant topcoat layer 12, such as a layer of a perfluoropolyether material, formed over the protective overcoat layer 11.

Each of layers 2-5 and the protective overcoat layer 11 may be formed utilizing at least one physical vapor deposition (PVD) method selected from sputtering, vacuum evaporation, ion plating, ion beam deposition, and plasma deposition, or at least one chemical deposition method selected from chemical vapor deposition (CVD), metal-organo chemical vapor deposition (MOCVD), and plasma-enhanced chemical vapor deposition (PECVD); and the lubricant topcoat layer 12 may be formed by at least one method selected from dipping, spraying, and vapor deposition.

The advantageous characteristics attainable by the present invention, particularly as related to reduction or elimination of DC noise, are illustrated in the following example.

### EXAMPLE

Magnetically soft underlayers (SULs) for perpendicular recording media frequently comprise FeCoB alloy films. However, such films in their as-deposited state typically are amorphous or comprise nano-crystallites embedded in an amorphous matrix, depending upon the B content. For example, as-deposited FeCoB films are amorphous when the B content is about 10% or greater (see C. L. Platt et al., IEEE Trans. Magn. July 2001). Since the as-deposited films are not as soft as heat-treated films, an appropriate heat treatment is required in order to obtain films suitable for use as soft underlayers (see Jun Yu et al., MMM 2001 Conference). The heat treatment modifies the stress-induced perpendicular anisotropy of the films, promotes in-plane anisotropy, and renders the films very soft in the in-plane direction. Although the films remain in the amorphous state after mild (gentle) heat treatment, relatively severe heat treatment results in local crystallization. When the films are crystallized, perpendicular anisotropy originating from magneto-crystalline anisotropy form ripple domains and cause DC noise in the SUL. Accordingly, the following experiments were performed with the aim of determining whether crystallization, thus ripple domain formation leading to DC noise generation in the SUL, could be prevented or at least minimized, by pseudo-lamination. (Fe₆₅Co₃₅)₈₈B₁₂ alloy films for use as SULs were fabricated using a multi vacuum chamber, single-disk sputtering apparatus. The films were sputtered onto unheated glass substrates by DC magnetron sputtering at a deposition rate of about 5.5-11 nm/sec. in a low Ar pressure atmosphere of about 3 mTorr and at about 2-4 kW target power. The target diameter was 7 inches and the targetsubstrate spacing was about 2 inches. Non-laminated (Fe₆₅Co₃₅)₈₈B₁₂ alloy films were deposited onto disk-shaped substrates by continuous deposition at a single deposition station; whereas bi-layer and tri-layer pseudo-laminated films were deposited using two and three consecutively arranged process stations, respectively. The total film thickness in each case was maintained constant at about 200 nm, and the films were heat-treated in one of the vacuum chambers at about 300-340° C. for about 8 sec., which conditions are required for deposition of a CoCr alloy magnetically hard recording layer.

Measurements of the non-laminated, bi-layer, and tri-layer SULs were performed on a Guzik Model 2585A/1701A test spin stand in order to quantitatively measure the amount of read-back noise of the SULs. The SUL read-back noise was obtained in the following manner: A wide band of each of the films on the disk-shaped substrate, i.e., a band about 4,000 μin. wide, was DC erased. The time domain read-back signals were captured for 0.5 msec. at a sampling rate of 1 Gs/sec., which time domain signals were converted to the frequency domain and further to the spatial frequency domain. The read-back noise was then obtained by integrating the noise in the spatial frequency domain and then normalizing to a 600 kfci signal. The excess SUL read-back noise was determined by subtracting the integrated electronic noise from the integrated SUL read-back noise.

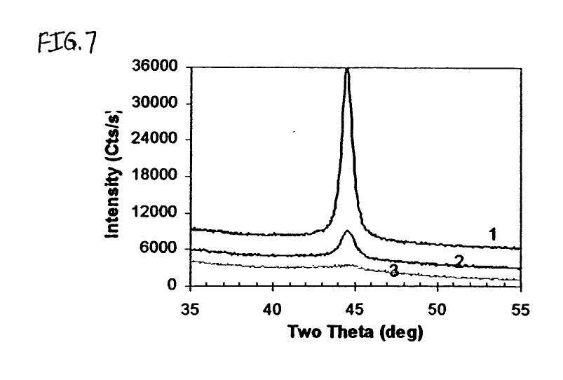

The spin stand measurements indicated that the pseudo-laminated SULs prepared under different sputtering powers consistently exhibited lower DC noise than the non-laminated SULs prepared under similar sputtering powers. Referring to FIGS. 5 and 6, respectively shown therein are graphs illustrating the DC noise spectrum of a conventional, non-laminated, 200 nm thick FeCoB SUL film and the DC noise spectrum of a 3-layer, pseudo-laminated, 200 nm thick FeCoB SUL film according to the present invention. As is clearly evident therefrom, significant DC noise is observed with the non-laminated SUL (FIG. 5), whereas substantially no noise is observed for the tri-layer pseudo-laminated SUL (FIG. 6), i.e., the noise power level of the latter remains constant at the electronic noise level over the entire frequency range of the measurement. By contrast, the noise power level of the non-laminated SUL is above the electronic noise level in the frequency range below about 150 kfci. The excess read-back noise of the non-laminated SUL was quantified as about 6.6 dB, which low frequency noise is attributable to the magnetic fields emanating from ripple domains. In addition, the excess SUL read-back noise of the non-laminated SULs measured by the spin stand test correlated well with the amount of ripple domains present therein, as observed by Magnetic Force Microscopy (MFM).

More specifically, MFM images of the non-laminated and bi-layer pseudo-laminated SULs indicated light and dark contrasting areas, whereas the MFM images of the tri-layer pseudo-laminated SULs were featureless. The light and dark contrasting areas are attributable to the magnetizations being canted up or down from the film plane, which areas are ripple domains in the SUL film. Such ripple domains are the result of partial crystallization of the films caused by thermal annealing, wherein the crystallization process results in local magneto-crystalline anisotropy which varies in direction and magnitude.

Referring now to FIG. 7, shown therein are X-ray diffraction patterns of the three types of SUL films, i.e., non-laminated, bi-layer pseudo-laminated, and tri-layer pseudo-laminated FeCoB films. As is clearly evident from FIG. 7, the intensity of the α-Fe (110) peak is highest for the non-laminated SUL film, weaker for the bi-layer pseudo-laminated SUL film, and weakest for the tri-layer pseudo-laminated SUL film. The relative amounts of ripple domains observed by MFM correlates well with the relative intensities of the α-Fe (110) peaks.

The above results demonstrate that the “pseudo-lamination” effect may be effectively utilized for reducing DC noise of the SUL of perpendicular magnetic recording media, by reducing ripple domain formation via reduced crystallization of heat-treated amorphous SUL films. For (Fe₆₅Co₃₅)₈₈B₁₂ alloys as SUL films formed on glass substrates, the thickness of each sub-layer of the pseudo-laminated SUL structures can be in the range from about 50 to about 130 nm, depending upon the heat treatment conditions, with thinner sub-layers being preferred regardless of the heat treatment conditions.

Thus, the present invention advantageously provides improved, high areal recording density, low noise, magnetic alloy-based perpendicular magnetic data/information recording, storage, and retrieval media including an improved pseudo-laminated, magnetically soft underlayer (SUL) structure with reduced occurrence or elimination of ripple domains therein advantageously providing a corresponding reduction or elimination of DC noise, while avoiding the difficulties and drawbacks associated with commercial-scale manufacture of conventional laminated SUL structures including alternating soft magnetic and spacer layers. As a consequence, the inventive methodology effectively eliminates, or at least suppresses, the generation of DC noise associated with soft underlayers of high bit density, perpendicular magnetic recording media.

The media of the present invention are especially useful when employed in conjunction with single-pole recording/retrieval transducer heads and enjoy particular utility in high recording density media for computer-related applications. In addition, the inventive media can be readily fabricated by means of conventional methodologies, e.g., sputtering techniques.

In the previous description, numerous specific details are set forth, such as specific materials, structures, processes, etc., in order to provide a better understanding of the present invention. However, the present invention can be practiced without resorting to the details specifically set forth. In other instances, well-known processing materials and techniques have not been described in detail in order not to unnecessarily obscure the present invention.

Only the preferred embodiments of the present invention and but a few examples of its versatility are shown and described in the present disclosure. It is to be understood that the present invention is capable of use in various other combinations and environments and is susceptible of changes and/or modifications within the scope of the inventive concept as expressed herein.

What is claimed is:

1. A high areal recording density, perpendicular magnetic recording medium with reduced or substantially zero DC noise, comprising:
(a) a non-magnetic substrate having a surface; and
(b) a layer stack formed over said substrate surface, said layer stack comprising, in overlying sequence from said substrate surface:
(i) a magnetically soft underlayer;
(ii) at least one non-magnetic interlayer; and
(iii) a magnetically hard perpendicular recording layer;
wherein said magnetically soft underlayer (b)(i) is thicker than said magnetically hard perpendicular recording layer (b)(iii) and is a pseudo-laminated structure composed of a stacked plurality of sub-layers of a magnetically soft material.

2. The magnetic recording medium as in claim 1, wherein:
said layer stack (b) further comprises an adhesion layer between said substrate surface and said magnetically soft underlayer (b)(i).

3. The magnetic recording medium as in claim 2, wherein:
said adhesion layer comprises an about 10 to about 50 Å thick layer of a material selected from the group consisting of Ti, Cr, Ta, Zr, Nb, Fe, Co, Ni, and alloys thereof.

4. The magnetic recording medium as in claim 1, wherein:
said magnetically soft underlayer (b)(i) is composed of a stacked plurality of sub-layers of a magnetically soft material selected from the group consisting of FeCoB, CoZr, CoZrCr, CoZrNb, CoTaZr, CoFeZr, and FeTaC.

5. The magnetic recording medium as in claim 4, wherein:
said magnetically soft underlayer (b)(i) is composed of a stacked plurality of sub-layers of a FeCoB alloy.

6. The magnetic recording medium as in claim 5, wherein:
said magnetically soft underlayer (b)(i) is composed of 2-6 stacked sublayers of (Fe₆₅Co₃₅)₈₈B₁₂ each having a thickness from about 50 to about 130 nm.

7. The magnetic recording medium as in claim 1, wherein:
said at least one non-magnetic interlayer (b)(ii) comprises an up to about 10 Å thick layer or layers of at least one non-magnetic material selected from the group consisting of Pt, Pd, Ta, Re, Ru, Hf, alloys thereof, Ti—Cr, and Co-based alloys.

8. The magnetic recording medium as in claim 1, wherein:
said magnetically hard perpendicular recording layer (b)(iii) is from about 100 to about 300 Å thick and comprises a Co-based alloy including one or more elements selected from the group consisting of Cr, Fe, Ta, Ni, Mo, Pt, V, Nb, Ge, and B, or an iron oxide selected from Fe₃O₄ and δ-Fe₂O₃, or a (CoX/Pd or Pt)ₙ multilayer magnetic superlattice structure comprised of alternating thin layers of a Co-based magnetic alloy and non-magnetic Pd or Pt, where n is an integer from about 10 to about 25, each of the alternating thin layers of Co-based magnetic alloy is from about 2 to about 3.5 Å thick, X is an element selected from the group consisting of Cr, Ta, B, Mo, and Pt, and each of the alternating thin layers of non-magnetic Pd or Pt is about 10 Å thick.

9. The magnetic recording medium as in claim 8, wherein:
said magnetically hard perpendicular recording layer (b)(iii) comprises a CoCrPt alloy.

10. The magnetic recording medium as in claim 1, wherein:
said non-magnetic substrate (a) comprises a material selected from the group consisting of Al, NiP-plated Al, Al—Mg alloys, other Al-based alloys, other non-magnetic metals, other non-magnetic alloys, glass, ceramics, polymers, glass-ceramics, and composites and/or laminates thereof.

11. The magnetic recording medium as in claim 1, further comprising:
(c) a protective overcoat layer over said magnetically hard perpendicular recording layer (b)(iii); and
(d) a lubricant topcoat layer over said protective overcoat layer (c).

12. The magnetic recording medium as in claim 1, wherein:
said non-magnetic substrate (a) comprises a material selected from the group consisting of Al, NiP-plated Al, Al—Mg alloys, other Al-based alloys, other non-magnetic metals, other non-magnetic alloys, glass, ceramics, polymers, glass-ceramics, and composites and/or laminates thereof; and
said layer stack (b) comprises:
an adhesion layer between said substrate surface and said magnetically soft underlayer (b)(i), said adhesion layer comprising an about 10 to about 50 Å thick layer of a material selected from the group consisting of Ti, Cr, Ta, Zr, Nb, Fe, Co, Ni, and alloys thereof;
a magnetically soft underlayer (b)(i) in the form of a pseudolaminated structure composed of 2-6 stacked sub-layers of a FeCoB alloy each having a thickness from about 50 to about 130 nm;
at least one non-magnetic interlayer (b)(ii) in the form of an up to about 10 Å thick layer or layers of at least one non-magnetic material selected from the group consisting of Pt, Pd, Ta, Re, Ru, Hf, alloys thereof, Ti—Cr, and Co-based alloys; and
a magnetically hard perpendicular recording layer (b)(iii) in the form of an about 100 to about 300 Å thick layer comprised of a Co-based alloy including one or more elements selected from the group consisting of Cr, Fe, Ta, Ni, Mo, Pt, V, Nb, Ge, and B, or an iron oxide selected from Fe₃O₄ and δ-Fe₂O₃, or a (CoX/Pd or Pt)ₙ multilayer magnetic superlattice structure comprised of alternating thin layers of a Co-based magnetic alloy and non-magnetic Pd or Pt, where n is an integer from about 10 to about 25, each of the alternating thin layers of Co-based magnetic alloy is from about 2 to about 3.5 A thick, X is an element selected from the group consisting of Cr, Ta, B, Mo, and Pt, and each of the alternating thin nonmagnetic layers of Pd or Pt is about 10 Å thick.

13. A method of manufacturing a high areal recording density, perpendicular magnetic recording medium with reduced or substantially zero DC noise, comprising the steps of:
(a) providing a non-magnetic substrate having a surface; and
(b) forming a layer stack over said substrate surface, comprising steps for forming, in overlying sequence from said substrate surface:
(i) a magnetically soft underlayer;
(ii) at least one non-magnetic interlayer; and
(iii) a magnetically hard perpendicular recording layer;
wherein step (b)(i) comprises forming a pseudo-laminated structure having a thickness greater than that of said magnetically hard perpendicular recording layer formed in step (b)(iii) and composed of a plurality of sub-layers of magnetically soft material.

14. The method according to claim 13, wherein:
step (b)(i) comprises forming a pseudo-laminated structure composed of a stacked plurality of sub-layers of a magnetically soft material selected from the group consisting of FeCoB, CoZr, CoZrCr, CoZrNb, CoTaZr, CoFeZr, and FeTaC.

15. The method according to claim 14, wherein:
step (b)(i) comprises forming a pseudo-laminated structure composed of a stacked plurality of sub-layers of a FeCoB alloy.

16. The method according to claim 15, wherein:
step (b)(i) comprises forming a pseudo-laminated structure composed of 2 -6 stacked sub-layers of (Fe₆₅Co₃₅)₈₈B₁₂ each having a thickness from about 50 to about 130 nm.

17. The method according to claim 13, wherein:
step (b)(i) comprises forming said pseudo-laminated structure by a physical vapor deposition (PVD) process.

18. The method according to claim 17, wherein:
step (b)(i) comprises forming said pseudo-laminated structure by a sputtering process.

19. The method according to claim 17, wherein:
step (b)(i) comprises forming said pseudo-laminated structure composed of a stacked plurality of sub-layers of a soft magnetic material by depositing each sub-layer in a different chamber.

20. The method according to claim 17, wherein:
step (b)(i) comprises forming said pseudo-laminated structure composed of a stacked plurality of sub-layers of a soft magnetic material by discontinuous, sequential deposition of each sub-layer in the same chamber.

21. The method according to claim 13, wherein:
step (b) further comprises forming an adhesion layer over said substrate surface prior to performing step (b)(i).

22. The method according to claim 21, wherein:
step (b) comprises forming said adhesion layer of an about 10 to about 50 Å thick layer of a material selected from the group consisting of Ti, Cr, Ta, Zr, Nb, Fe, Co, Ni, and alloys thereof.

23. The method according to claim 13, wherein:
step (b)(ii) comprises forming an up to about 10 A thick layer or layers of at least one non-magnetic material selected from the group consisting of Pt, Pd, Ta, Re, Ru, Hf, alloys thereof, Ti—Cr, and Co-based alloys.

24. The method according to claim 13, wherein:
step (b)(iii) comprises forming an about 100 to about 300 A thick layer comprised of a Co-based alloy including one or more elements selected from the group consisting of Cr, Fe, Ta, Ni, Mo, Pt, V, Nb, Ge, and B, or an iron oxide selected from Fe₃O₄ and δ-Fe₂O₃, or a (CoX/Pd or Pt)ₙ multilayer magnetic superlattice structure comprised of alternating thin layers of a Co-based magnetic alloy and non-magnetic Pd or Pt, where n is an integer from about 10 to about 25, each of the alternating thin layers of Co-based magnetic alloy is from about 2 to about 3.5 Å thick, X is an element selected from the group consisting of Cr, Ta, B, Mo, and Pt, and each of the alternating thin layers of non-magnetic Pd or Pt is about 10 Å thick.

25. The method according to claim 13, wherein:
step (a) comprises providing a non-magnetic substrate comprised of a material selected from the group consisting of Al, NiP-plated Al, Al—Mg alloys, other Al-based alloys, other non-magnetic metals, other non-magnetic alloys, glass, ceramics, polymers, glass-ceramics, and composites and/or laminates thereof.

26. A high areal recording density, perpendicular magnetic recording medium with reduced or substantially zero DC noise, comprising:
(a) a perpendicular magnetic recording layer; and
(b) means for reducing or substantially eliminating DC noise of said medium.

27. A disk drive comprising a low DC noise perpendicular magnetic recording medium including a pseudo-laminated soft underlayer structure according to claim 1.
